(19) United States
(12) Patent Application Publication
(10) Pub. No.: US 2018/0096295 A1
(43) Pub. Date: Apr. 5, 2018

(54) DELIVERY STATUS DIAGNOSIS FOR INDUSTRIAL SUPPLIERS

(71) Applicant: General Electric Company, Schenectady, NY (US)

(72) Inventors: Chris J. WANG, San Ramon, CA (US); Partha Pritam DEKA, San Ramon, CA (US); Beena AMMANATH, San Ramon, CA (US); Vikram LAKSHMIPATHY, San Ramon, CA (US)

(21) Appl. No.: 15/285,907

(22) Filed: Oct. 5, 2016

(51) Int. Cl. G06Q 10/08; G06Q 10/06

(52) U.S. Cl. CPC G06Q 10/0833; G06Q 10/067; G06Q 10/0838

(57) ABSTRACT

Provided are a system and method for determining a future delivery status of a purchase order. In one example, the method includes receiving delivery information about previous orders of a supplier, generating one or more models indicating whether an order of the supplier is going to be delivered on-time based on the delivery information about the previous orders, determining that a current order of the supplier is going to be delayed based on the one or more models, and outputting a user interface displaying an indication that the current order is going to be delayed. The system and method described herein can determine whether an industrial purchase order will be late at least six weeks in advance or more thus making it possible for customers to take alternative measures.

### BACKGROUND

Industrial suppliers build and repair machines and equipment that is used to maintain, repair, and operate facilities in all types of industries including manufacturing (electronic, chemical, biological, mechanical, etc.), healthcare, farming, hospitality, government, energy, and the like. Customers typically purchase parts/goods and services from suppliers directly or indirectly through an agent. The purchase process can vary, but typically suppliers send the customer a quote for an order of goods and/or services. The quote typically includes a price, availability, and a quantity of the items in the order. If the customer agrees to the details of the quote, a purchase order is given. The purchase order can have a number of different types including a standard (one-time purchase), planned (an agreement for an item at an approximate date or time), and blanket in which date and time of delivery are not specified. Purchase orders are normally accompanied by terms and conditions which form the contractual agreement of the transaction. The supplier then delivers the products or services and the customer records the delivery (in some cases this goes through a goods inspection process). An invoice is sent by the supplier which is cross-checked with the purchase order and documents specifying which goods have been received. The payment is then made and transferred to the supplier.

However, there are situations in which an order or part of an order is delayed for many reasons such as lack of materials, unexpected occurrences, negligence, and the like. In most of these cases, a customer is typically required to make payment (or at least partial payment) on the goods and/or services rendered, or surrender the entire order. Late deliveries not only impact the purchase order of the customer, but also impact customer sales on products in which they plan to use the parts/services. Furthermore, even just one late delivery can cause a customer to seek a new supplier. In some instances, a customer might better handle a delayed delivery if they were aware of such delay. However, customers are often not made aware of the delivery being delayed, and if they are, they are usually not made aware of how long of a delay there is going to be. In addition, customers do not have clear measurements to visualize and compare supplier delivery performance. Furthermore, customers lack tools to accurately forecast delivery date without solely relying on promised delivery dates provided by suppliers. Furthermore, there is an overall lack of visibility into causes of delayed deliveries which can make customers even more frustrated.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a system for diagnosing the delivery status of an industrial supplier in accordance with an example embodiment.

FIG. 2 is a diagram illustrating a system for diagnosing the delivery status of an industrial supplier in accordance with another example embodiment.

FIG. 3A-3C are diagrams illustrating sample accuracy levels of the system and method herein as performed on sample data, in accordance with example embodiments.

FIG. 4 is a diagram illustrating a method for diagnosing the delivery status of an industrial supplier in accordance with an example embodiment.

FIG. 5 is a diagram illustrating a device for diagnosing the delivery status of an industrial supplier in accordance with an example embodiment.

FIG. 6 is a diagram illustrating an example of visually displaying delivery status information in accordance with example embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide an understanding of the various example embodiments. It should be appreciated though that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed towards a system and method that can determine a delivery status of a purchase order up to six weeks in advance of an expected delivery date. Furthermore, the system can also diagnose the reasons for the delivery status (e.g., causes for a delay, earliness, timeliness, etc.). The determined delivery status and the delivery status diagnosis can be provided to a user/customer through a visual portal or user interface enabling the user to further understand when an order is delayed (or early), how much of a delay there is and why the order is delayed thereby allowing the user to take corrective action should the need exist. In some embodiments, the system generates one or more trained models, which will predict how early/late the deliveries will be. Accordingly, when the system receives a new order set for a future delivery date, the system then uses the previously trained models to determine the expected timing of the delivery made by the supplier based on the attributes/features of the order such as parts, supplier of the order, etc. Furthermore, a user interface can provide information about a delayed order or early order to a customer or user associated with the order. For example, the interface may display an indication that an order is going to be delayed, an expected date of delivery, an amount of delay (time), historic delivery order status of the supplier, and the like.

The example embodiments help end users predict delays in deliveries well in advance of scheduled delivery dates. The examples described herein integrate data by using historical data, collecting statistics for delayed deliveries, providing information on what may cause a delivery to be delayed, and the like. The embodiments also have the ability to predict in advance which deliveries may be delayed and display this information to a user. That data visualization can be customized. The use of the regression model in the example embodiments is unique. That is, the system may include a large number of suppliers and parts and multiple models may be built that are more relevant for specific cases. For example, each part and supplier combination may have its own model or plurality of models for analyzing whether a purchase order including the part will be delayed. Furthermore, an end user can determine the factors that cause the deliveries to be delayed.

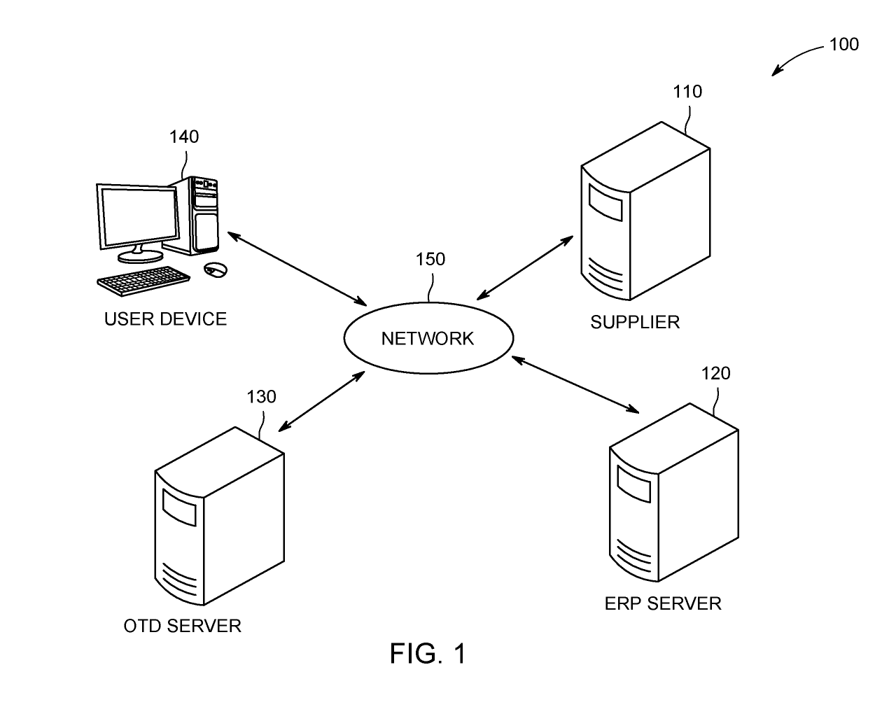

FIG. 1 illustrates a system 100 for diagnosing the delivery status of an industrial supplier in accordance with an example embodiment. Referring to FIG. 1, the system 100 includes a supplier system 110, an ERP server 120 associated with the supplier system 110, an on-time delivery (OTD) determination server 130, and a user device 140, which are connected to each other via a network 150 such as a wired and/or wireless network. For example, the network 150 may include a public network (e.g., the Internet), a private network, or a combination thereof. The supplier system 110 may be a server or plant computing device associated with an industrial supplier that receives and fulfills purchase orders from customers. A purchase order may include an agreed upon item/part for delivery, price, quantity, and date of delivery. The supplier system 110 may communicate with customers and also communicate with the ERP server 120 that is associated with the supplier. The supplier system may receive purchase orders and provide them to the ERP server 120. As another example, the supplier system 110 and the ERP server 120 may be the same system, or the supplier system may be omitted.

The ERP server 120 may include enterprise management software that allows an organization to use a system of integrated applications to manage a business and automate many back office functions related to technology, services and human resources. ERP software may integrate all facets of an operation including product planning, development, manufacturing, delivery, sales and marketing in a single database, application and user interface. The ERP server 120 may provide order information of the supplier to the OTD server 130. For example, the ERP server 120 may provide information about previous orders handled by the supplier and current orders in the process of being handled by the supplier, and orders received but not yet processed by the supplier. The ERP server 120 may provide the order information in response to a request, automatically (e.g., at a preset time, in response to an event, etc.), or through user control. Also, the ERP server 120 may provide a new order to the OTD server 130 when it is first received or in the first transmission since receiving the new order, and also provide updated information about the order in subsequent transmittals to the OTD server 130.

According to various embodiments, the OTD server 130 may generate one or more models indicating whether a current order is going to be delivered on time based on the historical data of previous orders of the supplier received from the ERP server 120. For example, the models may be linear regression based models that include inputs from information included in a current order such as a part and a supplier. Using the models, the OTD server 130 may determine whether delivery of a current order of the supplier is going to be delayed, early, or on-time, based on information about the current order and the one or more models. For example, information about the current order may be used as variable inputs into the one or more models. Also, the OTD server 130 may provide a user interface to the user device 140 to provide a user thereof with an indication that the current order is going to be on-time, delayed, or early. As a result, the user may be made aware well in advance that a purchase order is delayed thereby allowing the user to make alternative arrangements if necessary.

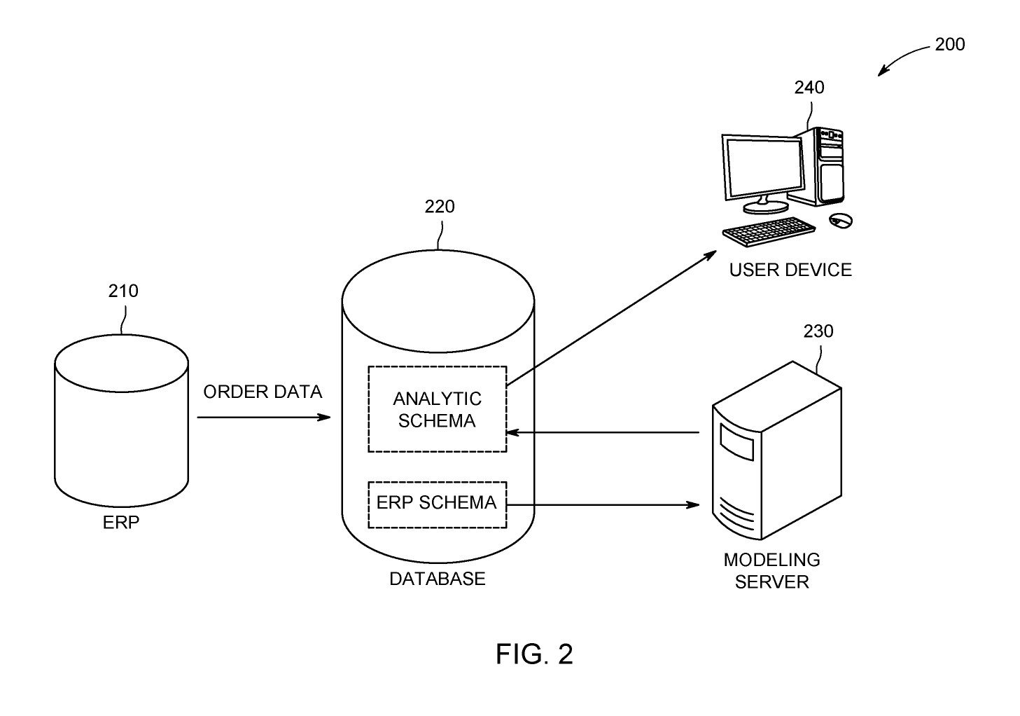

FIG. 2 illustrates a system 200 for diagnosing the delivery status of an industrial supplier in accordance with another example embodiment. The system 200 may be incorporated with the system 100 of FIG. 1, or it may a separate system. Referring to FIG. 2, the system 200 can diagnose industrial supplier delivery behavior by integrating data (e.g., big data) from various traditional systems, for example, one or more Enterprise Resource Planning (ERP) systems, and the like, into a database, for example, a Greenplum based distributed computing and storage environment. The system 200 develops analytics layers, and pre-processes the ERP data. The system is capable of investigating supplier delivery operational patterns using historic data and providing accurate prediction on the delivery status of future purchase orders as well as detailed statistics to help users pinpoint the specific reasons for delayed deliveries. Furthermore, the system provides a visualization of supplier part deliveries for future open orders (e.g., six weeks in advance) and enables business operations to highlight delivery issues well in advance as well as enable adequate stocking of inventory parts to ensure uninterrupted assembly operations thereby minimizing delays in meeting customer demands for the final products.

Referring to FIG. 2, the system 200 includes an ERP database 210, an analytical database 220, a modeling server 230, and a user device 240. In this example, the system 200 includes various attributes including data integration and pre-processing, model building and prediction, and visualization. In order to perform data integration, the analytical database 220 may detect or otherwise receive updates from the ERP database 210 including information about new purchase orders or current purchase orders being manufactured/processed by a supplier, modifications to existing purchase orders of the supplier, historical data about previous purchase orders processed by the supplier, and the like. The ERP information may be received automatically such as on a periodic basis, in response to an event triggering data transfer, and the like. As another example, the ERP information may be downloaded or transmitted to the analytical database 220 in response to a user command. Also, the ERP database 210 may be associated with the supplier. For example, the ERP database 210 may be stored in a cloud computing environment remote from the supplier, or it may be stored locally with the supplier. Here, the ERP database 210 and the analytical database may be connected through a network such as the Internet or a private network. As another example, the ERP database 210 may be incorporated with the analytical database 220 but is shown separately here for convenience of description.

The ERP data is transmitted to the modeling server 230 for model building and prediction. For example, the modeling server 230 may generate one or more models used to predict whether a delivery is going to be delayed, early, or on time. For example, the modeling server 230 may calculate data science attributes and build analytical layers to predict a delivery status of current purchase orders. The data input/output pipeline between the devices shown in the system 200 may be based on big data technology and concepts thus allowing the system 200 to be robust, fast and scalable.

Some of the features that may be performed by the modeling server 230 include missing value handling, data partitioning, variable transformation and selection, model building, and model validation. Based on the distribution and impact of missing values during testing, various approaches may be performed by the modeling server 230 for handling missing values including filtering, mean/median imputation, regression imputation or imputation based on similarity records by clustering. When performing data partitioning, the modeling server 230 may perform an identification of a supplier and a part in the order which may be the most informative and significantly correlated with time to delivery, however, the examples are not limited thereto. For example, the modeling server 230 may partition the data by a combination of a supplier and a respective part and then further divide the data into training and test datasets with random sampling so that a separate model can be built and validated for each unique supplier and part combination.

The modeling server 230 may also perform variable transformation and selection including correlations analysis and various data visualization techniques including scatter plots, histograms, partial dependence plots, box plots, normal qq-plots, and the like, which may be used to determine whether and how to transform the variables of the models. Similar data visualization techniques, inferential statistical analysis as well as business knowledge may then be applied to select a large initial set of variables. Stepwise regression, for example, by Akaike Information Criterion and Lasso Regression may then be applied to all variables and their two way interactions to select a set of significant variables. The modeling server 230 may also perform model building. In some examples, because of the small number of training observations per partition, regression based models may be used to reduce overfitting. Also, a separate model may be built for each unique supplier part combination based on the partitioned data.

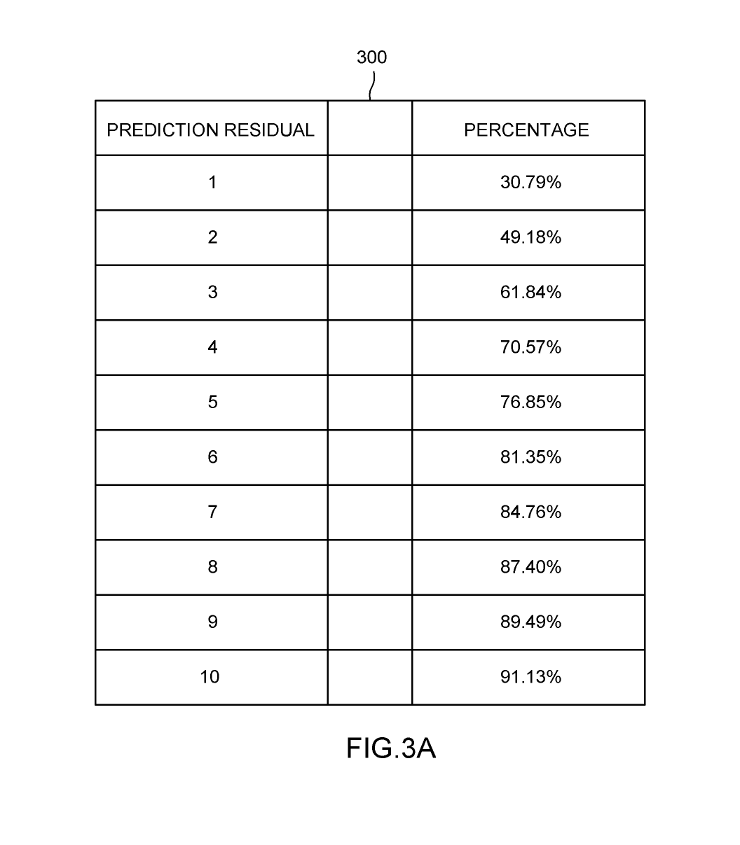

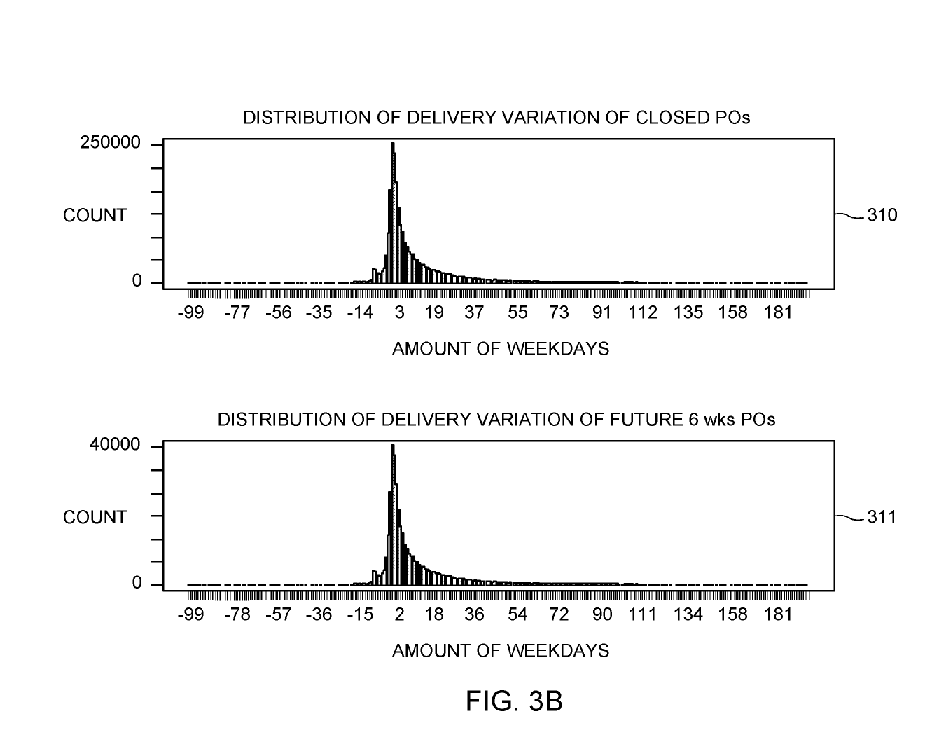

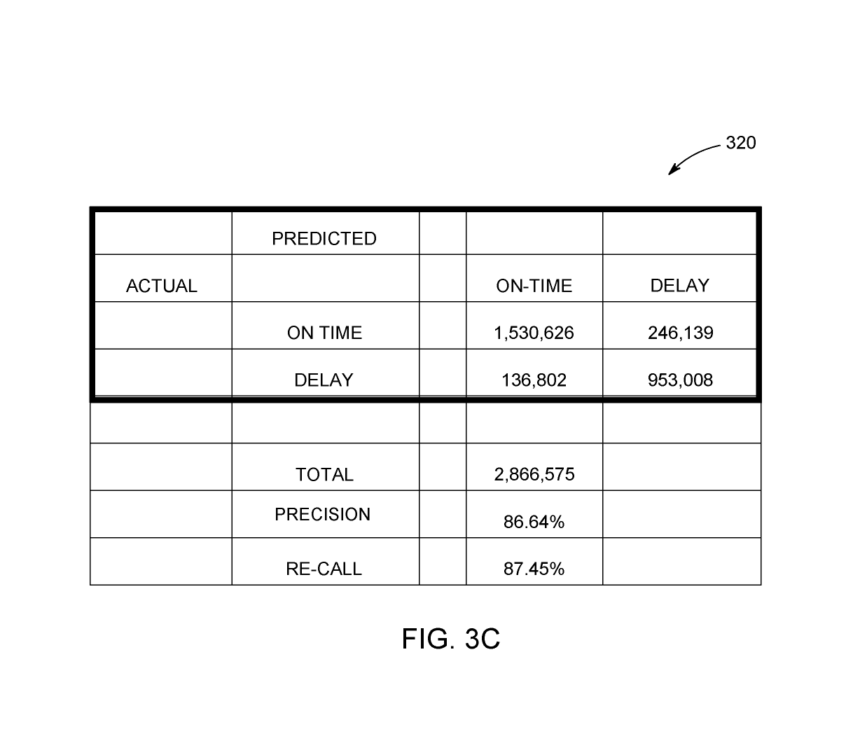

In addition to building the models, the modeling server 230 may validate the models. FIGS. 3A-3C illustrate accuracy levels of the system and method herein as performed on test data, in accordance with example embodiments. The performance of the models may be assessed on a sample test data for each partition separately and also as whole. During testing, adjusted r-squares were consistently above 98%. Referring to FIG. 3A, a table 300 showing prediction rates 300 is shown. In this example, 84.8% of predicted receipt dates in test datasets were within +/−7 days of actual receipt dates while 91.1% of predicted receipt dates in test datasets were within +/−10 days of actual receipt dates. As shown in FIG. 3A, in this example the prediction was over 70% accurate within +/−4 days of actual receipt dates. Referring to FIG. 3B, shown is a comparison of the historic delivery information on previous orders in 310 compared with predicted delivery information on current orders in 311. Furthermore, FIG. 3C illustrates a confusion matrix 320 showing how frequently the model according to various embodiments is able to correctly predict if a purchase order will be delayed. In this example, of the almost three million orders, roughly one million of them were predicted to be delayed which was 86% accurate.

The modeling server 230 may also generate one or more visualizations for an end user to view such as user device 240. For example, the modeling server 230 may analyze the current order and the previous orders based on one or more models and generate a user interface illustrating whether a purchase order will be delayed as well as other information about the purchase order and output the user interface to the user device 240. For example, after data science prediction is completed, the modeling server 230 may trigger the visualization module to demonstrate various OTD metrics. The displayed metrics may include the following calculations, days late bucketing for delivery of parts by suppliers (e.g., a supplier can be late by two days, two weeks, and the like), delinquency metrics (e.g., all missed POs by suppliers this week or all past due POs), span calculation for each supplier (e.g., quantity to be delivered multiplied by days late), and the like. The output metrics may be displayed on the screen of user device 240 and be interacted with a by a user of the user device 240.

The exemplary embodiments not only predict whether a delivery of a purchase order is going to be delayed, early or on time, it also predicts the number of days that the delivery is going to be delayed or early. The calculations behind the variable importance metrics provide additional insight to the customer. Also, the system may output interactive dashboards that can change based on user input. The systems herein may use multiple models and combine predictive data from the multiple models. An exploratory data set may be utilized by the system. The system may collect predicative data. The system may use big data technology. The system may pull or otherwise receive data from multiple systems. Although not limited thereto, the system may use a unique server (e.g., Linux Server), and a server (e.g., an R-server) to create coefficients for modeling. As a result, the system is able to predict a weekly data set. In testing, the entire system takes less than 2 hours to process.

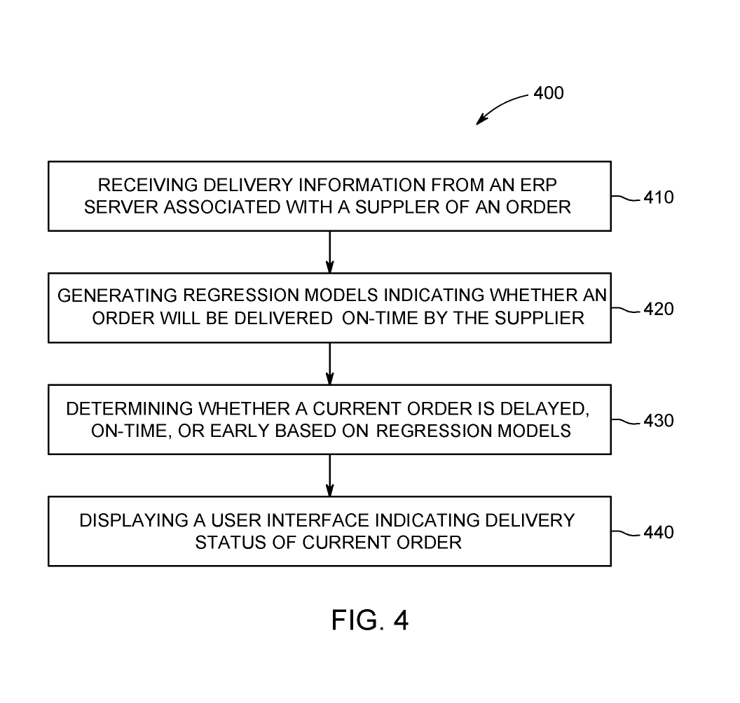

FIG. 4 illustrates a method 400 for diagnosing the delivery status of an industrial supplier in accordance with an example embodiment. For example, the method 400 may be performed by the OTD server 130 shown in FIG. 1, the modeling server 230 shown in FIG. 2, another device or combination of devices, and the like. Referring to FIG. 4, in 410 the method includes receiving delivery information about previous orders of a supplier from a database associated with the supplier. For example, the order may be a purchase order and the supplier may be an industrial supplier of parts included in the purchase order. Furthermore, the database may be an enterprise resource planning (ERP) database that includes business management software that collects, stores, manages, and interprets data from many business activities including product planning, purchasing, manufacturing/parts delivery, service delivery, marketing and sales, inventory and materials management, shipping and payment, finance, and the like. The ERP database may include detailed information about purchase orders previously handled by the supplier as well as current purchase orders (e.g., work in process) of the supplier that the supplier has not begun processing or is currently processing.

In 420, the method includes generating one or more models indicating whether an order is going to be late, early, or on-time, based on the delivery information about the previous orders of the supplier. For example, the models may be regression based models (e.g. linear regression based models) such as described with reference to FIG. 2, and may be based on previous order history information of the supplier. As another example, the regression based models may be based on individual parts or a group of parts included in a purchase order and the models may be based on previous order history information about on-time delivery status information of the part or group of parts.

The method further includes determining whether a current order of the supplier is going to be delayed, on-time, or early based on information about the current order and the one or more models, in 430, and displaying a user interface indicating the determined delivery status of the current order (e.g., the order is going to be delayed). Here, the models may be used to determine a number of days that an order is going to be late or a number of days an order is going to be early based on information about the order. The information about the current order may include one or more of an identification of a part included in the order and an indication of a supplier processing the order. In some examples, the determining may further include determining an expected delivery date of the current order based on the one or more models, and the output user interface may further display the expected delivery date of the current order. To determine a number of days an order is going to be delayed or early, an expected delivery date (i.e., predicted delivery date) of the current order determined from the one or more models may be compared with a quoted delivery date or an initially given delivery date of the current order. Also, in some embodiments, the determining may include determining a plurality of causes for the delay of the current order, and the output user interface further displays each respective cause on the display device. In some example, the method may further include determining a delivery trend of the supplier based on the current order and one or more of the previous orders, and the user interface further displays the delivery trend.

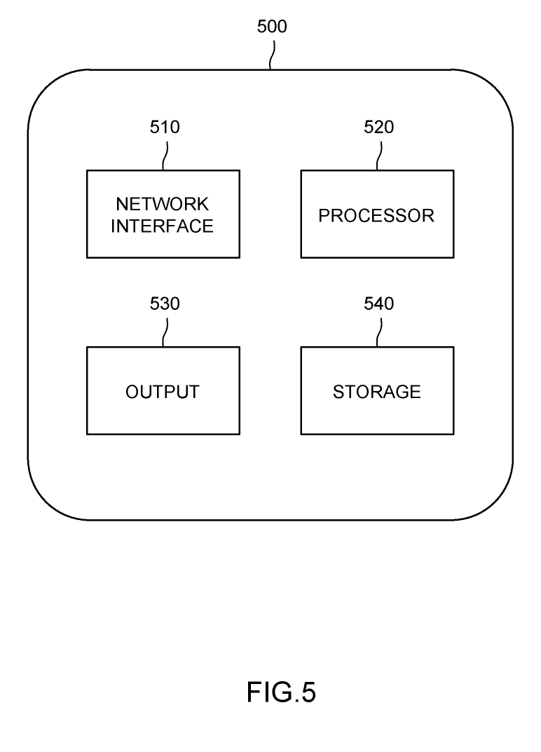

FIG. 5 illustrates a device 500 for diagnosing the delivery status of an industrial supplier in accordance with an example embodiment. For example, the device 500 may be the OTD server 130 of FIG. 1, the modeling server 230 of FIG. 2, or another device. Also, the device 500 may perform the method of FIG. 4. Referring to FIG. 5, the device 500 includes a network interface 510, a processor 520, an output 530, and a storage device 540. Although not shown in FIG. 5, the device 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

According to various embodiments, the network interface 510 may receive delivery information about previous orders of a supplier. For example, the delivery information may be deliveries of purchase orders previously handled by the supplier, and the supplier may include an industrial supplier of parts included in the purchase order. The network interface 510 may also receive information about current purchase orders being handled by the supplier such as new orders, and updates on previously received orders that are still being processed by the supplier. In some examples, the order information (e.g., previous and current) may be received from a database associated with the supplier such as a plant server, an ERP database, a cloud storage, and the like.

The processor 520 may generate one or more models indicating whether an order (e.g., a current purchase order handled by the supplier) is going to be delivered on-time, early, or late by the supplier based on the delivery information about the previous orders of the supplier. For example, the models may be regression based models such as linear regression, and the like. The processor 520 may determine that a purchase order is going to be early, on-time, or delayed based on information about the current order and the one or more models. For example, the information about the current order may include one or more variables for input into the one or more analytical models such as a part included in the order and a supplier of the order. In some examples, the processor 520 may generate a unique combination of supplier and part and use this combination as inputs into one or more models. The output 540 may output a user interface to a display device indicating that the determined delivery status of the current order. According to various embodiments, the device 500 may determine at least six weeks in advance that a purchase order scheduled to be fulfilled by a supplier is going to be delayed (i.e., late) and may provide an indication of how long the delay will be to a user through the user interface. As another example, the processor 520 may determine how early an order will be delivered, and the customer may be provided this information through the user interface.

In some embodiments, the processor 520 may determine an expected delivery date of the current order based on the one or more models, and the output 540 may display the expected delivery date of the current order on the display device. In this example, the processor 520 may determine that the current order is going to be delayed by comparing an expected delivery date of the current order determined from the one or more models with a quoted delivery date of the current order. In some examples, the processor 520 may determine a plurality of causes for the delay of the current order, and the output 540 may display an identification of each respective cause on the display device. In some embodiments, the processor 520 may determine a delivery trend of the supplier over a predetermined period of time based on the current order and one or more of the previous orders, and the output 540 may display the delivery trend.

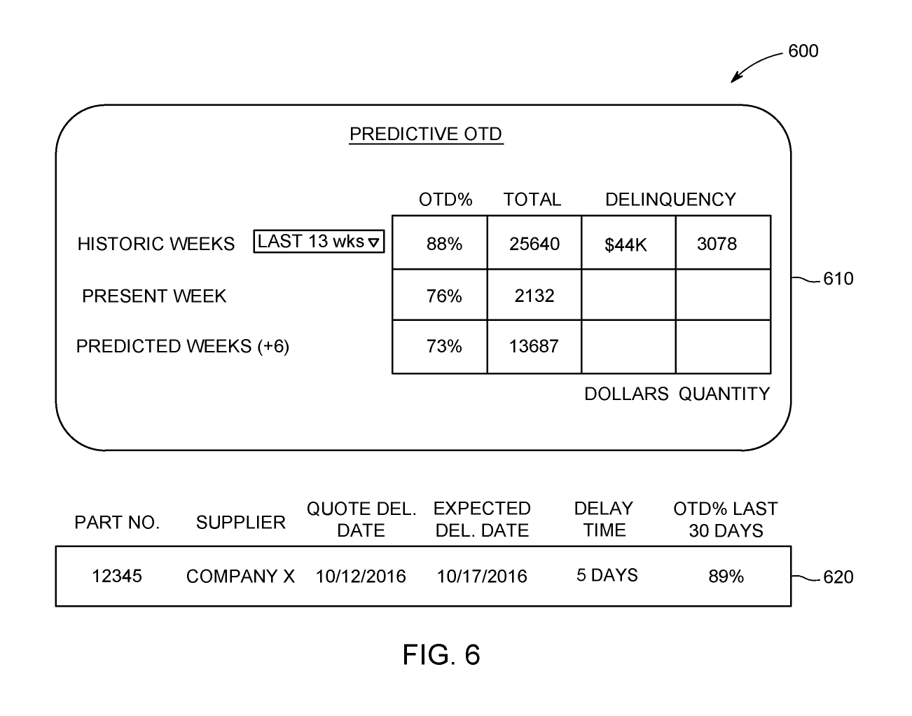

FIG. 6 illustrates an example of visually displaying delivery status information. Referring to FIG. 6, a user interface 600 is displayed, for example, on a display device, a screen, a touch pad, and the like. In this example, the user interface 600 includes an on-time delivery (OTD) status window 610 that provided delivery status information for a supplier. In this example, the OTD status window 610 provides a listing of historic on-time delivery information that represents a ratio of orders that have been delivered on-time versus orders that have not been delivered on-time during a predetermined amount of time (e.g., 13 weeks). In this example, 12% of all orders over the last 13 weeks have been delayed, or late, and 88% of the orders have been on-time or early. There is also a column for total number of orders and an optional delinquency column representing the cost of late orders. Furthermore, there is a drop-down box that allows a user to view any of the previous historic weeks from a predetermined period of time.

In addition to the historic delivery information, status window 610 also includes a row representing current delivery information indicating the delivery status of orders from the present week, and a row representing future delivery information indicating delivery status information determined for upcoming orders that have not yet been delivered but are quoted as being delivered during a predetermined period of time (e.g., the next 6 weeks). For example, the future delivery information may be determined based on one or more analytical models that predict of an order being on-time, late, or early and also predict how many days an order will be late or early. In some examples, the analytical models are regression models. In addition, the models may perform analysis of an order based on one or more variables such as supplier of the work order, one or more parts included in the work order, status of the supplier, materials needed for the work order, and the like.

The user interface 600 also includes an order part status window 620 indicating the delivery status of a particular part included in an order. In some cases, an order can include a plurality of parts or just one part. In this example, the order part status window 620 includes a name of the supplier for the part to be delivered, a quoted delivery date (initial scheduled delivery date), an expected delivery data (predicted deliver date based on one or more models), a determine delay time, and on-time delivery percentage of the supplier for the part over a predetermined period of time.

According to various embodiments, provided herein is a system and method for determining a delivery status of a future purchase order (e.g., late, on-time, early). The system and method may generate one or more models based on previous purchase orders delivered by the supplier. Based on the historic data, the one or more models can predict whether a pending purchase order will be delivered on-time, early, or late. In addition, the system and method may generate and output a user interface indicating that a purchase order is determined to be delayed at least six weeks ahead of time, or more. The user interface may also provide an expected date of delivery, delivery trends of the supplier, reasons for the delay in delivery, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing device for determining a delivery status of an order, the computing device comprising:
a network interface configured to receive delivery information about previous orders of a supplier;
a processor configured to generate one or more models indicating whether an order is going to be delivered on-time by the supplier based on the delivery information about the previous orders of the supplier, and determine that a current order of the supplier is going to be delayed based on information about the current order and the one or more models; and
an output configured to display a user interface indicating that the current order is going to be delayed.

2. The computing device of claim 1, wherein the order comprises a purchase order and the supplier comprises an industrial supplier of parts included in the purchase order.

3. The computing device of claim 1, wherein the information about the current order and the delivery information about the previous orders are received from an enterprise resource planning (ERP) database of the supplier.

4. The computing device of claim 1, wherein the processor is further configured to determine an expected delivery date of the current order based on the one or more models, and the output is further configured to display the expected delivery date of the current order on the display device.

5. The computing device of claim 1, wherein the processor is configured to determine that the current order is going to be delayed by comparing an expected delivery date of the current order determined from the one or more models with a quoted delivery date of the current order.

6. The computing device of claim 1, wherein the one or more models comprise one or more regression models.

7. The computing device of claim 1, wherein the processor is further configured to determine a plurality of causes for the delay of the current order, and the output is further configured to display an identification of each respective cause on the display device.

8. The computing device of claim 1, wherein the information about the current order comprises an identification of a part included in the order and a supplier of the order.

9. The computing device of claim 1, wherein the processor is further configured to determine a delivery trend of the supplier over a predetermined period of time based on the current order and one or more of the previous orders, and the output is further configured to display the delivery trend.

10. A method for determining a delivery status of an order, the method comprising:
receiving delivery information about previous orders of a supplier;
generating one or more models indicating whether an order is going to be delivered on-time by the supplier based on the delivery information about the previous orders of the supplier;
determining that a current order of the supplier is going to be delayed based on information about the current order and the one or more models; and
displaying, in a display device, a user interface indicating that the current order is going to be delayed.

11. The method of claim 10, wherein the order comprises a purchase order and the supplier comprises an industrial supplier of parts included in the purchase order.

12. The method of claim 10, wherein the information about the current order and the delivery information about the previous orders are received from an enterprise resource planning (ERP) database of the supplier.

13. The method of claim 10, further comprising determining an expected delivery date of the current order based on the one or more models,
wherein the output user interface further displays the expected delivery date of the current order to the user interface displayed on the display device.

14. The method of claim 10, wherein the determining that the current order is going to be delayed comprises comparing an expected delivery date of the current order determined from the one or more models with a quoted delivery date of the current order.

15. The method of claim 10, wherein the one or more models comprise one or more regression models.

16. The method of claim 10, further comprising determining a plurality of causes for the delay of the current order, and the output user interface further displays each respective cause on the display device.

17. The method of claim 10, wherein the information about the current order comprises an identification of a part included in the order and a supplier of the order.

18. The method of claim 10, further comprising determining a delivery trend of the supplier based on the current order and one or more of the previous orders, and the user interface further displays the delivery trend.

19. A non-transitory computer readable medium having stored therein instructions that when executed cause a computer to perform a method for determining a delivery status of an order, the method comprising:
receiving delivery information about previous orders of a supplier;
generating one or more models indicating whether an order is going to be delivered on-time by the supplier based on the delivery information about the previous orders of the supplier;
determining that a current order of the supplier is going to be delayed based on information about the current order and the one or more models; and
outputting a user interface to a display device, the output user interface displaying an indication that the current order is going to be delayed.

20. The non-transitory computer readable medium of claim 19, wherein the information about the current order and the delivery information about the previous orders are received from an enterprise resource planning (ERP) database of the supplier.
